(19) United States
(12) Patent Application Publication
(10) Pub. No.: US 2015/0106820 A1
(43) Pub. Date: Apr. 16, 2015

(54) METHOD AND APPARATUS FOR PROVIDING ALLOCATING RESOURCES

(71) Applicant: Alcatel-Lucent USA-Inc., Murray Hill, NJ (US)

(72) Inventors: Tirunell V. Lakshman, Morganville, NJ (US); Fang Hao, Morganville, NJ (US); Muralidharan Kodialam, Marlboro, NJ (US); Sarit Mukherjee, Morganville, NJ (US)

(73) Assignee: Alcatel-Lucent USA-Inc., Murray Hill, NJ (US)

(21) Appl. No.: 14/053,745

(22) Filed: Oct. 15, 2013

(51) Int. Cl. G06F 9/50

(52) U.S. Cl. CPC G06F 9/5011
USPC 718/104

(57) ABSTRACT

Various embodiments provide a method and apparatus for allocating resources to processes by using statistical allocation based on the determined maximum average resource demand at any time across all applications (“ μ̅”), and the determined maximum resource demand at any time by any application (“C”). In particular, resource allocation includes an auto-scaling scheme based on μ̅ and C.

### TECHNICAL FIELD

The invention relates generally to methods and apparatus for allocating resources.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

In some known resource allocation schemes, resource allocation is done at predefined points. For example, resource allocation may be done per-application or globally for all applications running on a provider's cloud by stating the scaling points in advance in a configuration file.

### SUMMARY OF ILLUSTRATIVE EMBODIMENTS

Some simplifications may be made in the following summary, which is intended to highlight and introduce some aspects of the various exemplary embodiments, but such simplifications are not intended to limit the scope of the inventions. Detailed descriptions of a preferred exemplary embodiment adequate to allow those of ordinary skill in the art to make and use the inventive concepts will follow in later sections

Various embodiments provide a method and apparatus for allocating resources to applications (e.g., application processes) by using statistical allocation based on the determined maximum average resource demand at any time across all applications (“ μ̅”) and the determined maximum resource demand at any time by any application (“C”). In particular, resource allocation includes an auto-scaling scheme based on μ̅ and C.

In a first embodiment, an apparatus is provided for providing resource allocation. The apparatus includes a data storage and a processor communicatively connected to the data storage. The processor is programmed to: determine a worst case average requirement; determine a maximum resource requirement; and determine a resource allocation scheme for a set of allocation steps based on the worst case average requirement and the maximum resource requirement.

In a second embodiment, a method is provided for providing resource allocation. The method includes: determining a worst case average requirement; determining, by the processor in cooperation with the data storage, a maximum resource requirement; and determining, by the processor in cooperation with the data storage, a resource allocation scheme for a set of allocation steps based on the worst case average requirement and the maximum resource requirement.

In a third embodiment, a non-transitory computer-readable storage medium is provided for storing instructions which, when executed by a computer, cause the computer to perform a method. The method includes: determining a worst case average requirement; determining a maximum resource requirement; and determining a resource allocation scheme for a set of allocation steps based on the worst case average requirement and the maximum resource requirement.

In some of the above embodiments, the processor is further programmed to determine a number of allocation steps. Where the set of allocation steps includes the determined number of allocation steps.

In some of the above embodiments, the processor is further programmed to collect a set of historical data. Where the worst case average requirement and the maximum resource requirement are based on at least a portion of the set of historical data.

In some of the above embodiments, the processor is further programmed to trigger determination of the resource allocation scheme based on a trigger event.

In some of the above embodiments, the method further includes determining a number of allocation steps. Where the set of allocation steps includes the determined number of allocation steps.

In some of the above embodiments, the method further includes collecting a set of historical data. Where the worst case average requirement and the maximum resource requirement are based on at least a portion of the set of historical data.

In some of the above embodiments, the method further includes triggering determination of the resource allocation scheme based on a trigger event.

In some of the above embodiments, the trigger event is based on resource utilization.

In some of the above embodiments, the worst case average requirement=maxₜμ(t); where μ(t) is the average amount of resources requested by an application at time t.

In some of the above embodiments, the maximum resource requirement=max_{i,t}hᵢ(t); where hᵢ(t) is the historical resource requirement for each application I at time t.

In some of the above embodiments, the resource allocation scheme is based on a Markov inequality.

In some of the above embodiments, the Markov inequality includes an objective to minimize an expected amount of resource allocation.

In some of the above embodiments, the resource allocation scheme is based on an adversarial approach.

In some of the above embodiments, the adversarial approach includes an adversary's objective to pick a density distribution that maximizes the expected amount of resources allocated to an application.

### BRIEF DESCRIPTION OF THE DRAWINGS

Various embodiments are illustrated in the accompanying drawings, in which:

FIG. 1 illustrates a network that includes an embodiment of a system 100 for providing resource allocation;

FIG. 2 depicts a flow chart illustrating an embodiment of a method 200 for a controller (e.g., controller 130 of FIG. 1) to allocate resources from multiple virtual machines (e.g., virtual machines 160 of FIG. 1);

FIG. 3 depicts a flow chart illustrating an embodiment of a method 300 for a controller (e.g., controller 130 of FIG. 1) to perform a k-step allocation scheme that allocates resources from multiple virtual machines (e.g., virtual machines 160 of FIG. 1) as illustrated in step 260 of FIG. 2; and

FIG. 4 schematically illustrates an embodiment of various apparatus 400 such as controller 130 of FIG. 1.

To facilitate understanding, identical reference numerals have been used to designate elements having substantially the same or similar structure or substantially the same or similar function.

### DETAILED DESCRIPTION OF ILLUSTRATIVE EMBODIMENTS

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

Various embodiments provide a method and apparatus for allocating resources to applications (e.g., application processes) by using statistical allocation based on the determined maximum average resource demand at any time across all applications (“ μ̅”) and the determined maximum resource demand at any time by any application (“C”). In particular, resource allocation includes an auto-scaling scheme based on μ̅ and C.

Advantageously, statistical allocation may be more robust to changes in user behavior and may provide resource auto-scaling that balances the number of resource allocations with application resource consumption.

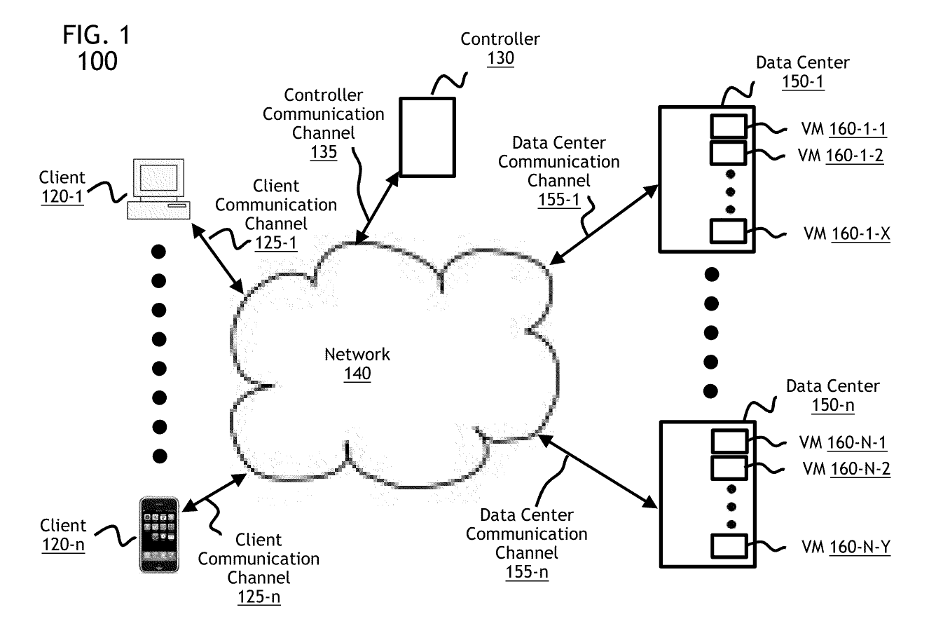

FIG. 1 illustrates a cloud network that includes an embodiment of a system 100 for providing resource allocation. The system 100 includes one or more clients 120-1-120-n (collectively, clients 120) accessing one or more application instances (not shown for clarity) residing in one or more virtual machines VM 160-1-1-VM 160-N-Y (virtual machines 160) in one or more data centers 150-1-150-n (collectively, data centers 150) over a communication path. The communication path includes an appropriate one of client communication channels 125-1-125-n (collectively, client communication channels 125), network 140, and one of data center communication channels 155-1-155-n (collectively, data center communication channels 155). Virtual machines providing resources to the application instances are allocated in one or more of data centers 150 by a controller 130 communicating with the data centers 150 via a controller communication channel 135, the network 140 and an appropriate one of data center communication channels 155.

Clients 120 may include any type of communication device(s) capable of sending or receiving information over network 140 via one or more of client communication channels 125. For example, a communication device may be a thin client, a smart phone (e.g., client 120-n), a personal or laptop computer (e.g., client 120-1), server, network device, tablet, television set-top box, media player or the like. Communication devices may rely on other resources within exemplary system to perform a portion of tasks, such as processing or storage, or may be capable of independently performing tasks. It should be appreciated that while two clients are illustrated here, system 100 may include fewer or more clients. Moreover, the number of clients at any one time may be dynamic as clients may be added or subtracted from the system at various times during operation.

The communication channels 125, 135 and 155 support communicating over one or more communication channels such as: wireless communications (e.g., LTE, GSM, CDMA, Bluetooth); WLAN communications (e.g., WiFi); packet network communications (e.g., IP); broadband communications (e.g., DOCSIS and DSL); storage communications (e.g., Fibre Channel, iSCSI) and the like. It should be appreciated that though depicted as a single connection, communication channels 125, 135 and 155 may be any number or combinations of communication channels.

Controller 130 may be any apparatus capable of allocating resources by using statistical allocation based on the determined maximum average resource demand at any time across all applications (“ μ̅”), and the determined maximum resource demand at any time by any application (“C”). For example, by allocating new application instances on virtual machines 160 in data centers 150 or re-assigning application instances to virtual machines 160. In particular, controller 130 includes an auto-scaling scheme that allocates application instances based on μ̅ and C. It should be appreciated that while only one controller is illustrated here, system 100 may include more controllers. It should be further appreciated that while depicted separately, one or more of data centers 150 may include controller 130. Furthermore, though depicted as communicating with data centers 150 via network 140, controller 130 may communicate with data centers 150 through any suitable communication network or may reside in the same communication network as one or more of data centers 150.

The network 140 includes any number of access and edge nodes and network devices and any number and configuration of links. Moreover, it should be appreciated that network 140 may include any combination and any number of wireless, or wire line networks including: LTE, GSM, CDMA, Local Area Network(s) (LAN), Wireless Local Area Network(s) (WLAN), Wide Area Network (WAN), Metropolitan Area Network (MAN), or the like.

The data centers 150 include one or more virtual machines 160. Each of virtual machines 160 may include any types or configuration of resources and service any type or number or application instances. Resources may be any suitable device utilized by a virtual machine to process requests from clients 120. For example, resources may be: servers, processor cores, memory devices, storage devices, networking devices or the like. In some embodiments, data centers 150 may be geographically distributed. It should be appreciated that while two data centers are illustrated here, system 100 may include fewer or more data centers.

In some embodiments, controller 130 allocates resources based on the current resource requirement of an application.

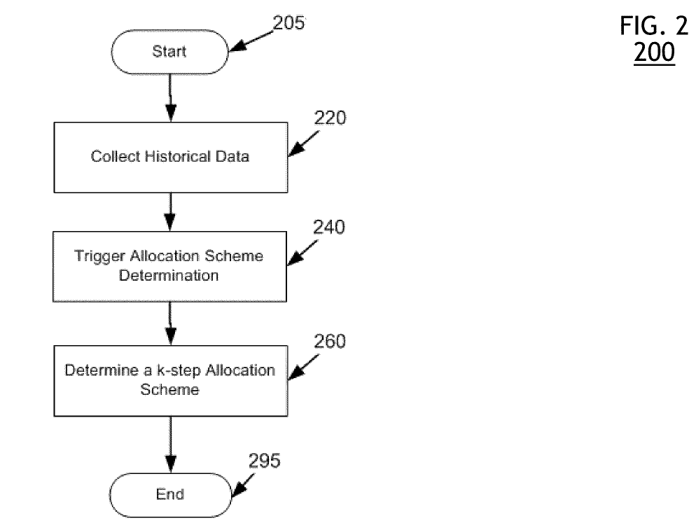

FIG. 2 depicts a flow chart illustrating an embodiment of a method 200 for a controller (e.g., controller 130 of FIG. 1) to allocate resources from multiple virtual machines (e.g., virtual machines 160 of FIG. 1). The method starts at step 205 and includes: collecting historical data (step 220); triggering an allocation scheme determination (step 240); determining a k-step allocation scheme (step 260); and ending at step 295.

In the method 200, the step 220 includes collecting historical data. In particular, historical data includes statistical information regarding resource requirements required to determine μ̅ and C. In some embodiments, the historical requirement curves for each application are collected.

In the method 200, the step 240 includes triggering an allocation scheme determination. An allocation scheme determination may be triggered by any suitable trigger event such as: 1) at predetermined intervals; 2) based on an external trigger such as an alarm or failure event; 3) based on resource utilization; or 4) based on collected historical data.

In the method 200, the step 260 includes determining a k-step allocation scheme based on μ̅ and C. In particular, applications are given resources in discrete increments or steps characterized by two parameters k, Δ and each of the k resource step sizes Δⱼ are determined based on μ̅ and C. Where k specifies the number of steps and the vector Δ denotes the individual step sizes. The step allocation scheme may be represented as S(k, Δ); where Δ=(Δ₁, Δ₂, . . . , Δₖ) are the step sizes. As an example, an application i may be allocated aᵢ(t)=Σⱼ₌₁^{w}Δⱼ resources. Where aᵢ(t) is the amount of resources allocated to user “i” at time t and w is the number of allocation steps. As an example of resource allocation, if an application requests resources greater than Δ₁, then the user is allocated an additional Δ₂ amount of resources. In some embodiments, for some i<k, when the application's resource requirements increases above a threshold such as Σⱼ₌₁ⁱ⁻¹Δⱼ, then the application is allocated an additional A amount of resources. Similarly, when an application's resource requirements falls below a threshold such as Σⱼ₌₁ⁱΔⱼ or Σⱼ₌₁ⁱΔⱼ−Buffer_{Threshold}, Δᵢ amount of resources may be freed. Where Buffer_{Threshold} provides a buffer to attempt to minimize fluctuation between allocation and de-allocation of resources when the resource requirements fluctuate close to a resource requirement border such as Δᵢ.

Advantageously, a k-step allocation scheme allows a provider to specify the number of allocation steps in order to strike a balance between resource wastage from over allocation and excessive reallocation overhead resulting from excessive readjustments.

In some embodiments of the method, the average of amount of resources requested by an application at time t is give as

$${\sum }_{𝓁}^{ } 𝓁 {p}_{𝓁} ( t ) = \frac{{\sum }_{i}^{ } {h}_{i} ( t )}{N ( t )} = μ ( t ) .$$

Where l is the amount of requested resources; pₗ(t) is the probability that a user requests units of resources at time t; N(t) is the number of active users at time time; hᵢ(t) is the historical resource requirement for each application i at time t and μ(t) is the average amount of resources requested by a user at time t. In some embodiments, μ̅=maxₜμ(t), which denotes the worst case average requirement for any time t. In some embodiments, C=max_{i,t}hᵢ(t), which denotes the maximum requirement for any application at any point in time.

In some embodiments of the step 240, the allocation scheme trigger is based on resource utilization. In some of these embodiments, as resource utilization or projected resource utilization (e.g., due to projected resources to be allocated or unavailable as a result of switchover from another failed data center) exceeds a threshold capacity, the number of steps “k” may be increased to improve resource utilization. In some embodiments, the resource allocation scheme may be selected based on the current or projected resource utilization.

In some embodiments of the step 240, the allocation scheme trigger is based on an external event. In some of these embodiments, the external event is a determination that a resource failure has occurred. A resource failure may be based on any suitable event such as: (1) failure of resources in a data center (e.g., one or more of data centers 150); (2) failure of network components such as network links; or (3) a failure that will require allocation of additional resources within one of the data centers such as a failure of one or more data centers or networks remote to the data centers.

In some embodiments of the step 240, the allocation scheme trigger is based on the ratio of the maximum request made by any application to the worst case mean request (i.e., the peak to mean ratio or “ρ”). In some embodiments,

$$ρ = \frac{C}{\overline{μ}} .$$

In some of embodiments of the step 260, the number of steps “k” is based on “ρ”. For example, the value of “k” may be set to a higher value if “ρ” exceeds a threshold. Advantageously, as “Σ” increases, the efficiency of the allocation scheme decreases, thus, by increasing the number of steps “k”, efficiency may be improved for higher peak to mean ratios “ρ”.

In some embodiments, a controller (e.g., controller 130 of FIG. 1) performs step 220. In some of these embodiments, the controller determines μ̅ and C and performs step 260 based on this determination.

In some embodiments, a measurement apparatus separate from the controller (e.g., controller 130 of FIG. 1) performs step 220. In some of these embodiments, the controller receives the collected historical data from measurement apparatus and then determines μ̅ and C and performs step 260 based on the received historical data. In some other embodiments, the measurement apparatus or another apparatus determines μ̅ or C and the controller receives the determined μ̅ and C and optionally the historical data from the measurement apparatus or another intermediary apparatus and performs step 260 based on at least a portion of the received information.

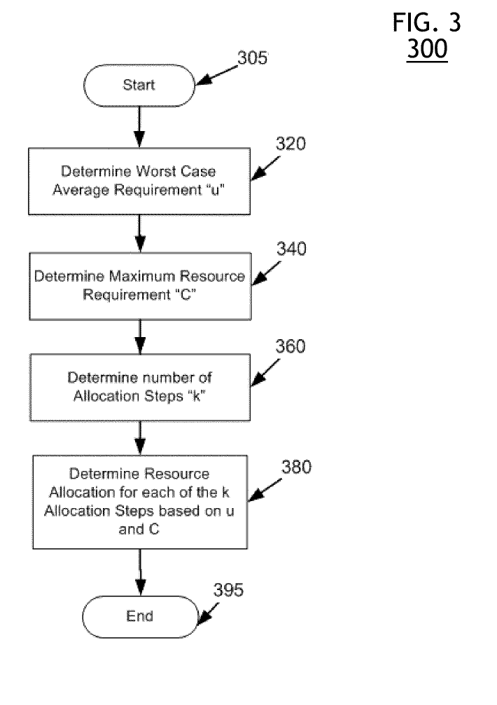

FIG. 3 depicts a flow chart illustrating an embodiment of a method 300 for a controller (e.g., controller 130 of FIG. 1) to perform a k-step allocation scheme that allocates resources from multiple virtual machines (e.g., virtual machines 160 of FIG. 1) as illustrated in step 260 of FIG. 2. The method starts at step 305 and includes: determining a worst case average requirement “ μ̅”; (step 320); determining a maximum resource requirement “C” (step 340); determining a number of allocation steps “k” (step 360); determining resource allocation for each of a “k” number of allocation steps based on μ̅ and C (step 380); and ending at step 395.

In the method 300, the step 320 includes determining a worst case average requirement “ μ̅ ” as described herein.

In the method 300, the step 340 includes determining a maximum resource requirement “C” as described herein.

It should be appreciated that the apparatus performing the method may determine μ̅ or C by deriving one or both of μ̅ or C from historical or other data or may determine μ̅ or C by receiving one or both of μ̅ or C from another apparatus such as the measurement apparatus described herein.

In the method 300, the step 360 includes determining a number of allocation steps “k”. The number of allocations steps “k” may be determined in any suitable manner such as: (1) set by a provider or user; (2) determined based on system status such as resource utilization; (3) or the like.

In the method 300, the step 380 includes determining resource allocation for each of the k allocation steps based on μ̅ and C.

In some embodiment of the step 340, the sum of all of the resource steps is equal to C. For example, Σⱼ₌₁^{k}Δⱼ=C. In some other embodiments, to account for growth, the sum of all of the resource steps is equal to C multiplied by a growth factor (e.g., 10%) or is equal to C plus a growth threshold (e.g., a threshold value of a resource such as 1 GB of bandwidth or disk space). For example, Σⱼ₌₁^{k}Δⱼ=C*Growth_{factor}.

In some embodiments of the step 360, the value of k is based on the amount of available resources. In some of these embodiments, the number of resource allocation steps k is increased when the amount of available resources falls below a threshold level. Advantageously, by increasing the number of allocation steps k, allocation is more efficient, thereby improving resource utilization.

In some embodiments of the step 360, the number of resource allocation steps k is increased in response to an external event such as a failure trigger signaling that a portion of the available resources will be required for failure recovery.

In some embodiments of the step 380, the value of one or more of the allocation steps are disparate.

In some embodiments of the step 380, the resource allocation is based on first moment information. In some of these embodiments, the first moment information is based on a Markov inequality where the Markov inequality is used to upper bound the probability that a particular resource allocation step is exceeded. In some of these embodiments, the value of each of the reallocation steps is determined based on equation [E.1].

$${Δ}_{j} = \{ \begin{matrix}{\overline{μ} ( \frac{C}{\overline{μ}} )}^{\frac{1}{\overline{k}}} , & if j = 1 \\ {\overline{μ} ( \frac{C}{\overline{μ}} )}^{\frac{j}{\overline{k}}} ( \frac{C}{\overline{μ}} - 1 ) , & if j = 2 , 3 , … , k\end{matrix} \qquad [ Eq . 1 ]$$

In some embodiments of the step 380, the k-step allocation scheme is based on an adversarial approach where the adversarial approach approximates the resource increments such that the expected amount of resource is minimized for the worst case distribution that has mean μ̅ and maximum C. In some embodiments, the value of each of the reallocation steps is determined based on equation [E.2].

$${Δ}_{j} = \{ \begin{matrix}\frac{\overline{μ}}{k - 1} {( \frac{( k - 1 ) C}{\overline{μ}} )}^{\frac{1}{\overline{k}}} , & if j = 1 \\ \frac{\overline{μ}}{k - 1} {( \frac{( k - 1 ) C}{\overline{μ}} )}^{\frac{j}{\overline{k}}} - {( \frac{( k - 1 ) C}{\overline{μ}} )}^{\frac{j - 1}{\overline{k}}} , & if j = 2 , 3 , … , k\end{matrix} \qquad [ Eq . 2 ]$$

In some embodiments of the step 380, one or more of Δⱼ are subdivided into l sub-steps. In some of these embodiments, Δ₁ is subdivided into l sub-steps. In some of these embodiments, the subdivision of Δ₁ is based on [Eq. 1] or [Eq. 2] where k is replaced by l, C is replaced by Δ₁, and μ̅ is replaced by μ(t, Δ₁).

In some embodiments of the step 380, the resource allocation is further based on a class of density functions represented by D( μ̅, C). Where Φ denotes a density function with C probabilities, φ₁, φ₂, . . . φ_{C} where φⱼ represents the probability that the random variable takes on value j and where Φ ∈ D( μ̅, C) if:

Σⱼ₌₁^{C}jφⱼ≦ μ̅;

Σⱼ₌₁^{C}φⱼ=1; and

φⱼ≧0∀j.

In some embodiments of the step 380, the Markov inequality objective is to choose Δⱼ values in order to minimize the expected amount of resource allocation (i.e., E(A)). In some of these embodiments, E(A)=Σⱼ₌₁^{k}pⱼcⱼ; where pⱼ=Σ_{l=c}_{_{j−1}}₊₁^{C}^{ⱼ}φₗ and is defined as the probability that the jth block of resources was allocated to the application.

In some embodiments of the step 380, the adversary's objective is to pick a distribution φ ∈ D( μ̅, C) that maximizes the expected amount of resources allocated to the application.

Although primarily depicted and described in a particular sequence, it should be appreciated that the steps shown in methods 200 and 300 may be performed in any suitable sequence. Moreover, the steps identified by one step may also be performed in one or more other steps in the sequence or common actions of more than one step may be performed only once.

It should be appreciated that steps of various above-described methods can be performed by programmed computers. Herein, some embodiments are also intended to cover program storage devices, e.g., data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable data storage media. The embodiments are also intended to cover computers programmed to perform said steps of the above-described methods.

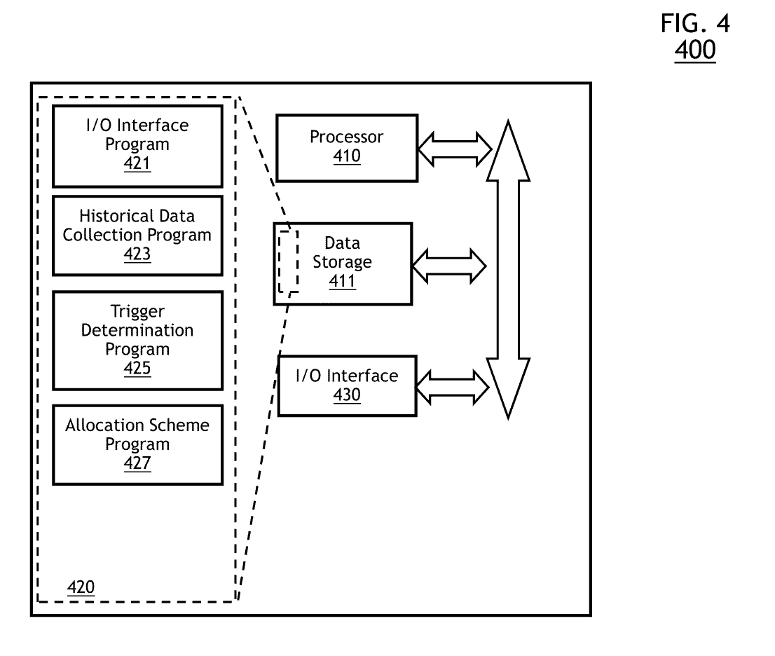

FIG. 4 schematically illustrates an embodiment of an apparatus 400 such as controller 130 of FIG. 1. The apparatus 400 includes a processor 410, a data storage 411, and an I/O interface 430.

The processor 410 controls the operation of the apparatus 400. The processor 410 cooperates with the data storage 411.

The data storage 411 stores programs 420 executable by the processor 410. Data storage 411 may also optionally store program data such as historical data, k, μ̅, C or the like as appropriate.

The processor-executable programs 420 may include an I/O interface program 421, a historical data collection program 423, a trigger determination program 425 or an allocation scheme program 427. Processor 410 cooperates with processor-executable programs 420.

The I/O interface 430 cooperates with processor 410 and I/O interface program 421 to support communications over controller communication channel 135 of FIG. 1 as described above.

The historical data collection program 423 performs step 220 of FIG. 2 as described above.

The trigger determination program 425 performs step 240 of FIG. 2 as described above.

The allocation scheme program 427 performs the steps of method(s) 300 of FIG. 3 or 260 of FIG. 2 as described above.

In some embodiments, the processor 410 may include resources such as processors/CPU cores, the I/O interface 430 may include any suitable network interfaces, or the data storage 411 may include memory or storage devices. Moreover the apparatus 400 may be any suitable physical hardware configuration such as: one or more server(s), blades consisting of components such as processor, memory, network interfaces or storage devices. In some of these embodiments, the apparatus 400 may include cloud network resources that are remote from each other.

In some embodiments, the apparatus 400 may be virtual machine. In some of these embodiments, the virtual machine may include components from different machines or be geographically dispersed. For example, the data storage 411 and the processor 410 may be in two different physical machines.

When processor-executable programs 420 are implemented on a processor 410, the program code segments combine with the processor to provide a unique device that operates analogously to specific logic circuits.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated that any block diagrams herein represent conceptual views of illustrative circuitry embodying the principles of the invention. Similarly, it should be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. An apparatus for providing resource allocation, the apparatus comprising:
a data storage; and
a processor communicatively connected to the data storage, the processor being configured to:
determine a worst case average requirement;
determine a maximum resource requirement; and
determine a resource allocation scheme for a set of allocation steps based on the worst case average requirement and the maximum resource requirement.

2. The apparatus of claim 1, wherein the processor is further configured to:
determine a number of allocation steps;
wherein the set of allocation steps includes the determined number of allocation steps.

3. The apparatus of claim 1, wherein the processor is further configured to:
collect a set of historical data;
wherein the worst case average requirement and the maximum resource requirement are based on at least a portion of the set of historical data.

4. The apparatus of claim 3, wherein the processor is further configured to:
trigger determination of the resource allocation scheme based on a trigger event.

5. The apparatus of claim 4, wherein the trigger event is based on resource utilization.

6. The apparatus of claim 1, wherein the worst case average requirement=maxₜμ(t); where μ(t) is the average amount of resources requested by an application at time t.

7. The apparatus of claim 6, wherein the maximum resource requirement=max_{i,t}hᵢ(t); where hᵢ(t) is the historical resource requirement for each application I at time t.

8. The apparatus of claim 1, wherein the resource allocation scheme is based on a Markov inequality.

9. The apparatus of claim 8, wherein the Markov inequality includes an objective to minimize an expected amount of resource allocation.

10. The apparatus of claim 1, wherein the resource allocation scheme is based on an adversarial approach.

11. The apparatus of claim 10, wherein the adversarial approach includes an adversary's objective to pick a density distribution that maximizes the expected amount of resources allocated to an application.

12. A method for providing resource allocation, the method comprising:
at a processor communicatively connected to a data storage, determining a worst case average requirement;
determining, by the processor in cooperation with the data storage, a maximum resource requirement; and
determining, by the processor in cooperation with the data storage, a resource allocation scheme for a set of allocation steps based on the worst case average requirement and the maximum resource requirement.

13. The method of claim 12, wherein the method further comprises:
determining, by the processor in cooperation with the data storage, a number of allocation steps;
wherein the set of allocation steps includes the determined number of allocation steps.

14. The method of claim 12, wherein the method further comprises:
collecting, by the processor in cooperation with the data storage, a set of historical data;
wherein the worst case average requirement and the maximum resource requirement are based on at least a portion of the set of historical data.

15. The method of claim 14, wherein the method further comprises:
triggering, by the processor in cooperation with the data storage, determination of the resource allocation scheme based on a trigger event.

16. The method of claim 15, wherein the trigger event is based on resource utilization.

17. The method of claim 12, wherein the worst case average requirement=maxₜμ(t); where μ(t) is the average amount of resources requested by an application at time t.

18. The method of claim 12, wherein the maximum resource requirement=max_{i,t}hᵢ(t); where hᵢ(t) is the historical resource requirement for each application i at time t.

19. The method of claim 12, wherein the resource allocation scheme is based on a Markov inequality.

20. The method of claim 12, wherein the resource allocation scheme is based on an adversarial approach.

21. A non-transitory computer-readable storage medium storing instructions which, when executed by a computer, cause the computer to perform a method, the method comprising:
determining a worst case average requirement;
determining a maximum resource requirement; and
determining a resource allocation scheme for a set of allocation steps based on the worst case average requirement and the maximum resource requirement.
